(19) United States
(12) Patent Application Publication
(10) Pub. No.: US 2009/0009501 A1
(43) Pub. Date: Jan. 8, 2009

(54) Luminance sensing apparatus

(75) Inventor: Mikio Shiba, Tokyo (JP)

Correspondence Address: REED SMITH LLP, Suite 1400, 3110 Fairview Park Drive, Falls Church, VA, 22042, US

(73) Assignees: Armorlink SH Corp.; ICP Electronics Inc.

(21) Appl. No.: 12/007,847

(22) Filed: Jan. 16, 2008

(30) Foreign Application Priority Data
Jul. 6, 2007 (TW) 096211052

(51) Int. Cl. G09G 5/00

(52) U.S. Cl. 345/207

(57) ABSTRACT

The invention discloses a luminance sensing apparatus for sensing the luminance of any area on a panel. The luminance sensing apparatus comprises a base, a first shaft, a first actuator, a second shaft, a second actuator, and at least one luminance sensor. The first shaft is pivotally connected to the base, and the second shaft is pivotally connected to the first shaft. The luminance sensor is disposed on the second shaft. The first actuator is used for actuating the first shaft to rotate with respect to the base, and the second actuator is used for actuating the second shaft to rotate with respect to the first shaft, such that the luminance sensor on the second shaft is capable of sensing luminance of any area on the panel. Accordingly, the luminance on the panel can be uniformly calibrated.

### BACKGROUND OF THE INVENTION

1. Field of the Invention

The invention relates to a luminance sensing apparatus and, more particularly, to a luminance sensing apparatus capable of sensing luminance of any area on a panel.

2. Description of the Prior Art

Liquid crystal display (LCD) production is one of the most significant and most competitive industries in the present. Furthermore, the backlight module is one of the most critical components to provide LCDs with a light source. The quality of backlight module will directly affect the efficacy of LCD because the LCD emits light by utilizing the backlight module. Moreover, the luminance and uniformity are two significant indices for the estimation of the quality. Presently, there are two common ways for measuring—estimating by naked eyes or by instruments.

Please refer to FIG. 1. FIG. 1 is a schematic diagram illustrating a conventional luminance sensing apparatus 1 disposed on a panel 2. As depicted in FIG. 1, because the luminance sensing apparatus 1 is disposed in a fixed position on the panel 2, the luminance sensor 10 of the luminance sensing apparatus 1 can only sense the luminance of this fixed position. In other words, the luminance sensing apparatus 1 can not sense the luminance of any area on the panel 2, so the luminance on the panel 2 can not be uniformly calibrated.

Please refer to FIG. 2. FIG. 2 is a schematic diagram illustrating a conventional luminance sensing apparatus 3 disposed on a panel 4. As depicted in FIG. 2, a luminance sensing apparatus 3 is disposed on a panel 4, and the luminance sensing apparatus 3 comprises a rotatable shaft 32 and a luminance sensor 30 disposed on the shaft 32. Although the shaft 32 can rotate along the direction of double arrow 5, still the luminance sensor 30 on the shaft 32 can only sense the luminance of specific area on the panel 4. In other words, the luminance sensing apparatus 3 can not sense the luminance of any area on the panel 4, so the luminance on the panel still can not be uniformly calibrated.

Therefore, the main scope of the invention is to provide a luminance sensing apparatus to solve the aforesaid problems.

### SUMMARY OF THE INVENTION

A scope of the invention is to provide a luminance sensing apparatus capable of sensing the luminance of any area on the panel, so as to uniformly calibrate the luminance on the panel.

According to a preferred embodiment, the luminance sensing apparatus of the invention is used for sensing luminance of any area on the panel. The luminance sensing apparatus comprises a base, a first shaft, a first actuator, a second shaft, a second actuator and at least one luminance sensor.

The first shaft is pivotally connected to the base through a first pivot and the second shaft is pivotally connected to the first shaft through a second pivot. The luminance sensor is disposed in a suitable position on the second shaft. The first actuator, disposed on the base and connected to the first pivot, is used for actuating the first shaft to rotate with respect to the base. The second actuator, disposed in the first shaft and connected with the second pivot, is used for actuating the second shaft to rotate with respect to the first shaft, such that the luminance sensor on the second shaft is capable of sensing luminance of any area on the panel. Accordingly, the luminance on the panel can be uniformly calibrated.

The advantage and spirit of the invention may be understood by the following recitations together with the appended drawings.

### BRIEF DESCRIPTION OF THE APPENDED DRAWINGS

FIG. 1 is a schematic diagram illustrating a conventional luminance sensing apparatus disposed on a panel;

FIG. 2 is a schematic diagram illustrating a conventional luminance sensing apparatus disposed on a panel;

FIG. 3A is a schematic diagram illustrating a luminance sensing apparatus disposed on a panel according to an embodiment of the invention;

FIG. 3B is a lateral view illustrating the luminance sensing apparatus shown in FIG. 3A;

FIG. 4 is a perspective view illustrating the luminance sensing apparatus 6 shown in FIG. 3B;

FIG. 5A is a schematic diagram illustrating a luminance sensing apparatus disposed on a panel according to another embodiment of the invention;

FIG. 5B is a lateral view illustrating the luminance sensing apparatus disposed on a panel shown in FIG. 5A; and

FIG. 6 is a perspective view illustrating the luminance sensing apparatus disposed on a panel shown in FIG. 5B.

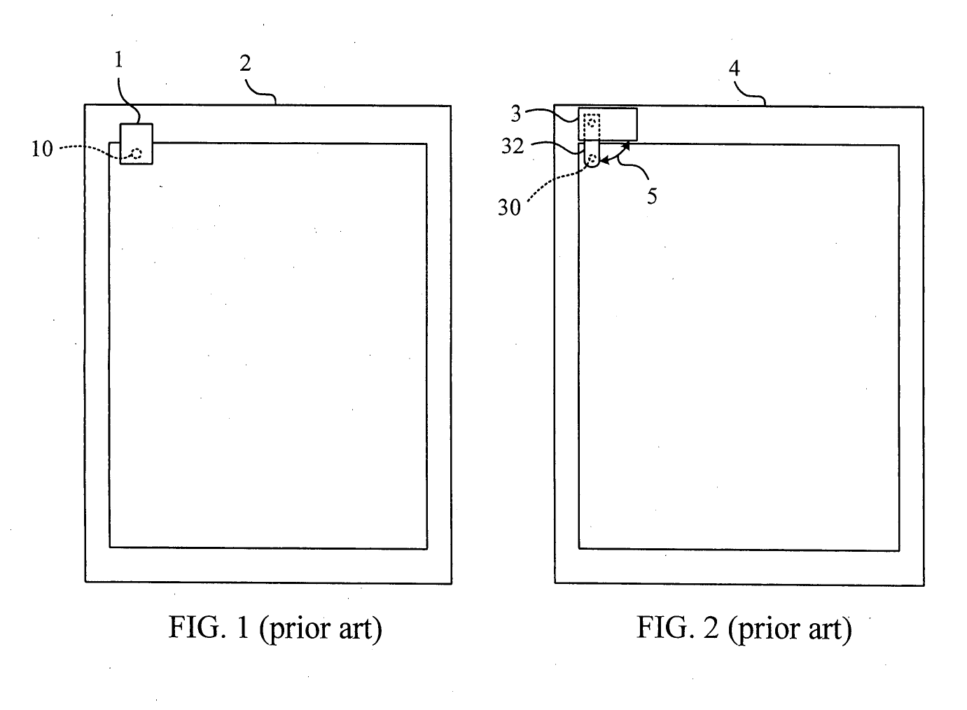

### DETAILED DESCRIPTION OF THE INVENTION

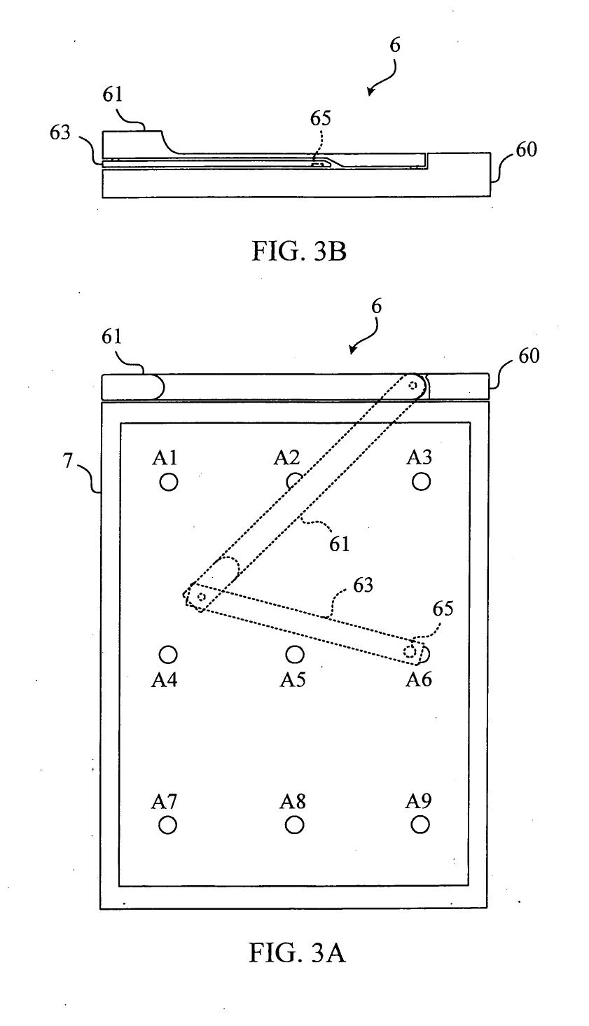

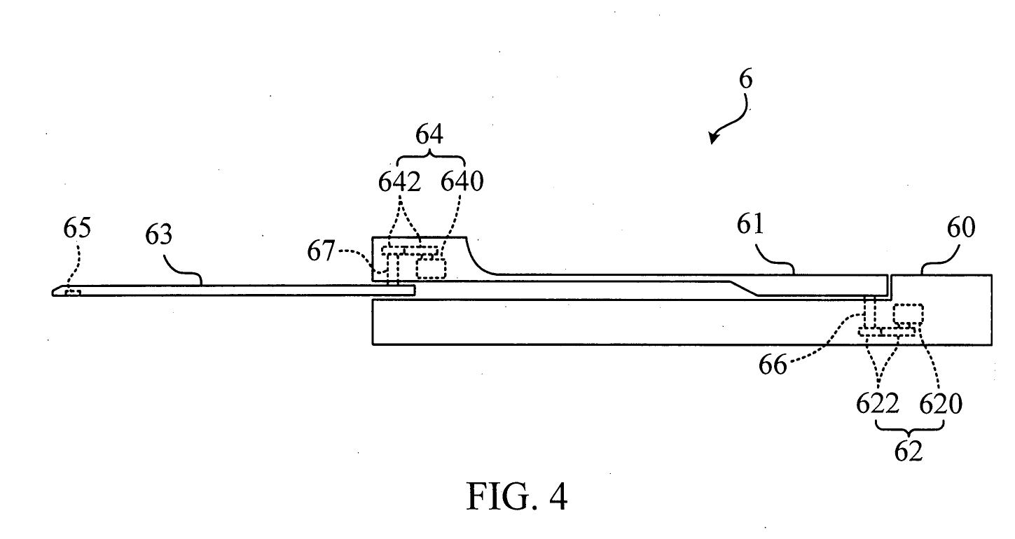

Please refer to FIG. 3A through FIG. 4. FIG. 3A is a schematic diagram illustrating a luminance sensing apparatus 6 disposed on a panel 7 according to an embodiment of the invention. FIG. 3B is a lateral view illustrating the luminance sensing apparatus 6 shown in FIG. 3A. FIG. 4 is a perspective view illustrating the luminance sensing apparatus 6 shown in FIG. 3B.

The luminance sensing apparatus 6 is used for sensing luminance of any area from A1 to A9 on the panel 7. In this embodiment, the areas A1-A9 are arranged in array, but not limited to this. In other words, the areas on the panel 7 can be arranged in any form according to practical applications.

As depicted in FIG. 3A through FIG. 4, the luminance sensing apparatus 6 comprises a base 60, a first shaft 61, a first actuator 62, a second shaft 63, a second actuator 64 and a luminance sensor 65. In this embodiment, only one luminance sensor 65 is disposed in a suitable position on the second shaft 63, but not limited to this. In other words, the invention can dispose more than two luminance sensors 65 on the second shaft 63 according to practical applications.

As depicted in FIG. 4, the first shaft 61 is pivotally connected to the base 60 through the first pivot 66, and the second shaft 63 is pivotally connected to the first shaft 61 through the second pivot 67. The first actuator 62, disposed on the base 60 and connected to the first pivot 66, is used for actuating the first shaft 61 to rotate with respect to the base 60. The second actuator 64, disposed in the first shaft 61 and connected to the second pivot 67, is used for actuating the second shaft 63 to rotate with respect to the first shaft 61, such that the luminance sensor 65 on the second shaft 63 is capable of sensing luminance of any area from A1 to A9 on the panel 7.

In this embodiment, the first actuator 62 comprises a first motor 620 and a first gear set 622, which connects the first motor 620 and the first pivot 66. The second actuator 64 comprises a second motor 640 and a second gear set 642, which connects the second motor 640 and the second pivot 67. The first actuator 62 actuates the first motor 620 and the first gear set 622 to rotate the first shaft 61 with respect to the base 60. In the same way, the second actuator 64 actuates the second motor 640 and the second gear set 642 to rotate the second shaft 63 with respect to the first shaft 61.

In practical applications, when the first shaft 61 rotates with respect to the base 60 and/or the second shaft 63 rotates with respect to the first shaft 61, the luminance sensor 65 is capable of sensing luminance of any area from A1 to A9 on the panel 7. Accordingly, the luminance on the panel 7 can be uniformly calibrated.

In this embodiment, the first motor 620 and the second motor 640 can be a stepping motor or a servo motor.

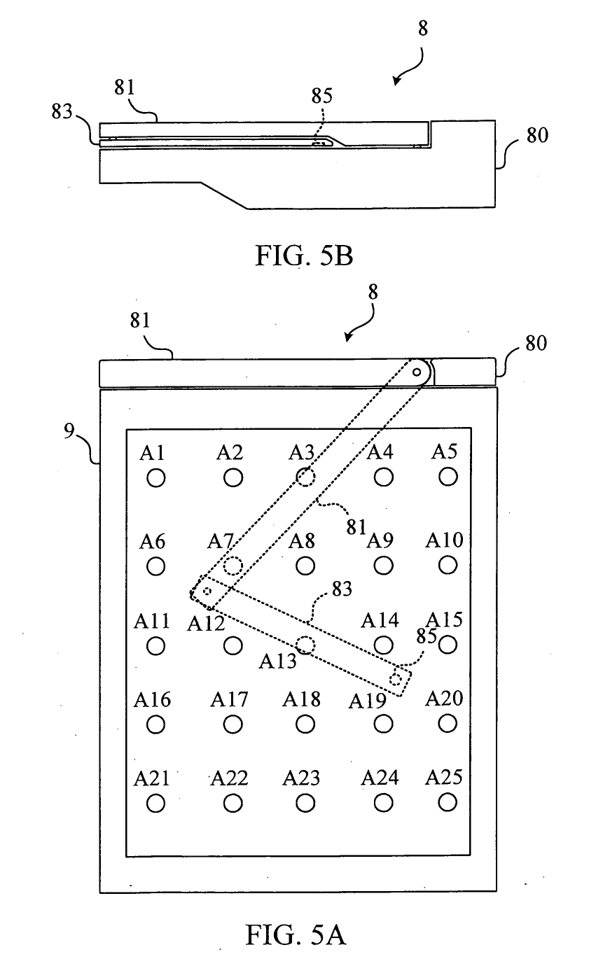

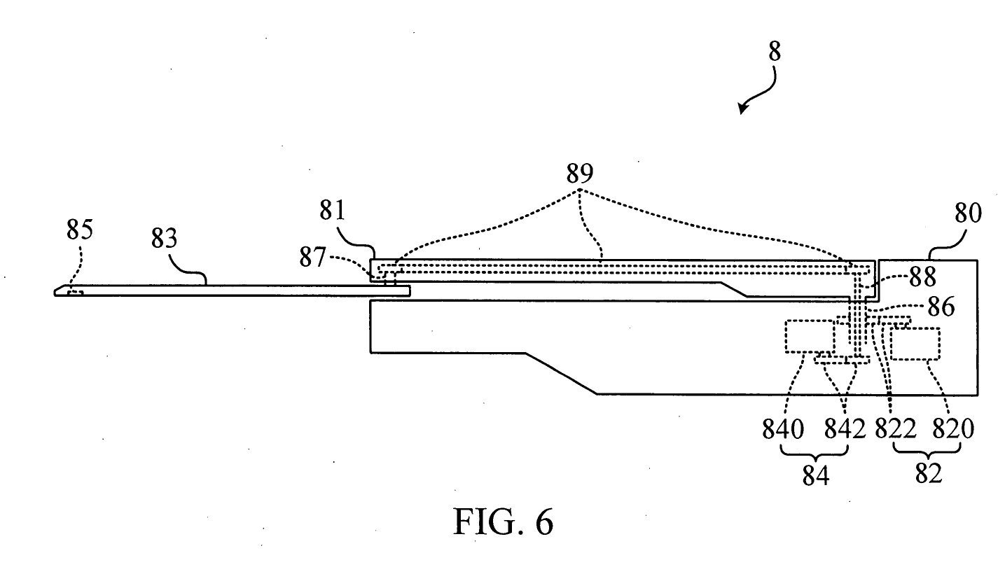

Please refer to FIG. 5A through FIG. 6. FIG. 5A is a schematic diagram illustrating a luminance sensing apparatus 8 disposed on a panel 9 according to another embodiment of the invention. FIG. 5B is a lateral view illustrating the luminance sensing apparatus 8 shown in FIG. 5A. FIG. 6 is a perspective view illustrating the luminance sensing apparatus 8 shown in FIG. 5B.

The luminance sensing apparatus 8 is used for sensing luminance of any area A1-A25 on the panel 9. In this embodiment, the areas A1-A25 are arranged in array, but not limited to this. In other words, the areas on the panel 7 can be arranged in any form according to practical applications.

As depicted in FIG. 5A through FIG. 6, the luminance sensing apparatus 8 comprises a base 80, a first shaft 81, a first actuator 82, a second shaft 83, a second actuator 84, a luminance sensor 85 and a pulley 86. In this embodiment, only one luminance sensor 85 is disposed in a suitable position on the second shaft 83, but not limited to this. In other words, the invention can dispose more than two luminance sensors 85 on the second shaft 83 according to practical applications.

As depicted in FIG. 6, the first shaft 81 is pivotally connected to the base 80 through the first pivot 86 and the second shaft 83 is pivotally connected to the first shaft 81 through the second pivot 87. The third pivot 88 is disposed in the first pivot 86. The pulley 89, disposed in the first shaft 81, is used for connecting the first pivot 86 and the third pivot 88. The first actuator 82, disposed on the base 80 and connected to the first pivot 86, is used for actuating the first shaft 81 to rotate with respect to the base 80. The second actuator 84, disposed on the base 80 and connected to the third pivot 88, is used for actuating the pulley 89 to actuate the second shaft 83 to rotate with respect to the first shaft 81, such that the luminance sensor 85 on the second shaft 83 is capable of sensing luminance of any area from A1 to A25 on the panel 9.

In this embodiment, the first actuator 82 comprises a first motor 820 and a first gear set 822, which connects the first motor 820 and the first pivot 86. The second actuator 84 comprises a second motor 840 and a second gear set 842, which connects the second motor 840 and the second pivot 87. The first actuator 82 actuates the first motor 820 and the first gear set 822 to rotate the first shaft 81 with respect to the base 80. In the same way, the second actuator 84 actuates the second motor 840, the second gear set 842 and the pulley 86 to rotate the second shaft 83 with respect to the first shaft 81.

In practical applications, when the first shaft 81 rotates with respect to the base 80 and/or the second shaft 83 rotates with respect to the first shaft 81, the luminance sensor 85 is capable of sensing luminance of any area from A1 to A25 on the panel 9. Accordingly, the luminance on the panel 9 can be uniformly calibrated.

In this embodiment, the first motor 820 or the second motor 840 can be a stepping motor or a servo motor.

Compared with prior art, the luminance sensing apparatus of the invention respectively actuates two shafts to rotate by two actuators, so as to sense luminance of any area on the panel. Accordingly, the luminance on the panel can be uniformly calibrated.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A luminance sensing apparatus for sensing luminance of any area on a panel, comprising:
a base;
a first shaft pivotally connected to the base through a first pivot;
a first actuator, disposed on the base and connected to the first pivot, for actuating the first shaft to rotate with respect to the base;
a second shaft pivotally connected to the first shaft through a second pivot;
at least one luminance sensor disposed in a suitable position on the second shaft; and
a second actuator, disposed in the first shaft and connected with the second pivot, for actuating the second shaft to rotate with respect to the first shaft, such that the at least one luminance sensor is capable of sensing luminance of any area on the panel.

2. The luminance sensing apparatus of claim 1, wherein the first actuator comprises a first motor and a first gear set, which connects the first motor and the first pivot.

3. The luminance sensing apparatus of claim 2, wherein the first motor is a stepping motor or a servo motor.

4. The luminance sensing apparatus of claim 1, wherein the second actuator comprises a second motor and a second gear set, which connects the second motor and the second pivot.

5. The luminance sensing apparatus of claim 4, wherein the second motor is a stepping motor or a servo motor.

6. A luminance sensing apparatus for sensing luminance of any area on a panel, comprising:
a base;
a first shaft pivotally connected to the base through a first pivot;
a first actuator, disposed on the base and connected to the first pivot, for actuating the first shaft to rotate with respect to the base;
a second shaft pivotally connected to the first shaft through a second pivot;
a third pivot disposed in the first pivot;
a pulley, disposed in the first shaft, for connecting the first pivot and the third pivot;
at least one luminance sensor disposed in a suitable position on the second shaft; and
a second actuator, disposed on the base and connected to the third pivot, for actuating the pulley to actuate the second shaft to rotate with respect to the first shaft, such that the at least one luminance sensor is capable of sensing luminance of any area on the panel.

7. The luminance sensing apparatus of claim 6, wherein the first actuator comprises a first motor and a first gear set, which connects the first motor and the first pivot.

8. The luminance sensing apparatus of claim 7, wherein the first motor is a stepping motor or a servo motor.

9. The luminance sensing apparatus of claim 6, wherein the second actuator comprises a second motor and a second gear set, which connects the second motor and the third pivot.

10. The luminance sensing apparatus of claim 9, wherein the second motor is a stepping motor or a servo motor.
